(19) United States
(12) Patent Application Publication
(10) Pub. No.: US 2014/0374680 A1
(43) Pub. Date: Dec. 25, 2014

(54) Screw-driven lifting platform

(71) Applicant: Lingchu Tsang, HongKong (CN)

(72) Inventor: Lingchu Tsang, HongKong (CN)

(21) Appl. No.: 13/642,854

(22) PCT Filed: Aug. 24, 2012
(86) PCT No.: PCT/CN12/80529

§ 371 Date: Nov. 14, 2012

(30) Foreign Application Priority Data
Mar. 5, 2012 (CN) 201220078087.0

(51) Int. Cl. B66F 11/04; B66F 7/06; B62B 3/06; B66F 5/02

(52) U.S. Cl. CPC B66F 11/042; B66F 5/025; B66F 7/0658; B66F 7/0666; B62B 3/0625; B62B 3/0612
USPC 254/7 C

(57) ABSTRACT

A screw-driven lifting platform, includes a lifting portion and a transmitting portion, which is characterized in comprising a base, a left-and-right screw thread rod, a left and a right group (two group in total) of X-shaped connecting rods and a horizontal lifting platform, wherein two groups (a left group and a right group) of the X-shaped connecting rods are respectively provided on left and right end portions between the base and the horizontal lifting platform, fixed ends of the X-shaped connecting rod are respectively hinged on the base and the horizontal lifting platform, movable ends of the X-shaped connecting rod are connected with the left-and-right screw thread rod, when the left-and-right screw thread rod rotates, the movable ends of the left and right groups of the X-shaped connecting rod are driven to move, so as to realize lifting and lowering the horizontal lifting platform.

### CROSS REFERENCE OF RELATED APPLICATION

This is a U.S. National Stage under 35 U.S.C 371 of the International Application PCT/CN2012/080529, filed Aug. 24, 2012.

### BACKGROUND OF THE PRESENT INVENTION

1. Field of Invention

The present invention relates to a lifting machinery, and more particularly to a screw-driven lifting platform.

2. Description of Related Arts

Lifting platforms on the market today all utilize an oil-pressure pump to drive levers to work in a scissor type. The drawback of single scissor type lies in requiring a stationary fulcrum and a moving fulcrum to work, so that the higher the platform rises, the smaller the distance between the two fulcrums is. Further more, when one of the fulcrums is moving to center of gravity on the platform, the other fulcrum is fixed on the end edge of the platform. Thus, the higher the platform raises, the less stable the platform is. When a worker is working on the side of the moving fulcrum, the weight of the worker will be increased due to lever principle, so the stability of the platform further decreases. Therefore, the foundation support of the lifting platform on the market nowadays is undoubtedly very heavy, so as to fight against the situation that the higher the platform raises, the less stable the platform is (See FIG. 1). Thus, situations that a crane is a must in transporting (cost factors) appear, and it is difficult to move the lifting platform in work places due to great weight thereof. In order to move the lifting platform, several workers are often required, which leads to a waste of working hours. Therefore, it is rarely seen that lifting platforms are adopted in decoration and small-scale projects, and herring bone ladders and steel frame platforms are often adopted therein. The herring bone ladders also have disadvantages of unstability in high position, and the steel frame platforms are not capable of being regulated steplessly. Moreover, when the herring bone ladders are adopted, workers have to climb up and down to cause physical decline and hard working, which further leads to a decline in work efficiency since operational height is not suitable, and workers are easy to have an accident.

Health care costs, insurance expenses, physical disability, injury or loss of life, and labor lawsuits caused by this are countless, which is a great loss and injury to society and families. Thus, if a light and stable lifting platform is provided, security of small-scale projects and decoration projects, and working efficiency can be improved, and losses in society can be reduced.

A patent of publication number RU2027624C1 discloses a “Lift truck for dismounting and transportation of equipment”, which has frame 3 mounted on running wheels 1. Installed on frame is load platform lifted by means of drive with two parallelogram mechanisms whose levers 5 are hinge-connected to each other and to frame 3 and load platform 11 for turning in longitudinal and vertical planes. Drive has shaft 7 with threaded sections with different sense of thread. Nuts 6 are hinge joints of levers 5. With handwheel 14 being turned, nuts 6 move along shaft 7 making levers 5 fold up or down which provides lifting or lowering of platform 1 as needed.

Referring to the publication documents and the applying drawings, the shaft 7 is connected with a border of the frame 3, and the frame 3 has the nuts 6 provided thereon. The lower end of the lever 5 is connected with the frame 3, and the upper end of the lever 5 is connected with the nut 6, which means that the upper end of the lever 5 is connected with the shaft 7. Thus, the frame 3, the lever 5 and the shaft 7 form a triangular structure. A triangle is the most stable shape. When the nut 6 moves along the shaft 7 in a straight line, the lever 5 moves in a circle around the lower end thereof. However, the lever 5 is impossible to move in a circle within the limits of the shaft 7. Therefore, the structure disclosed is non-enable. In addition, problems such as lack of stability and incapability of lifting horizontally also exist in the structure disclosed.

After searching, no same or similar techniques of the present invention are disclosed.

### SUMMARY OF THE PRESENT INVENTION

An object of the present invention is to provide a screw-driven lifting platform. With a lifting platform comprising a base, a horizontal lifting platform, a left-and-right screw thread rod, and two groups (a left group and a right group) of X-shaped connecting rods, driving the two groups of X-shaped connecting rods to move by the left-and-right screw thread rod, an effect and object of lifting and lowering the horizontal lifting platform are realized. In addition, the horizontal lifting platform of the present invention is capable of realizing a multilayered lifting structure and meeting the higher working requirement.

A technical solution to realize the present invention is as following. A screw-driven lifting platform, comprises a lifting portion and a transmitting portion, specifically, the screw-driven lifting platform comprises a base, a left-and-right screw thread rod, two groups (a left group and a right group) of X-shaped connecting rods and a horizontal lifting platform, wherein the two groups of the X-shaped connecting rods are respectively provided on left and right end portions between the base and the horizontal lifting platform, fixed ends of the X-shaped connecting rod are respectively hinged on the base and the horizontal lifting platform, movable ends of the X-shaped connecting rod are connected with the left-and-right screw thread rod, when the left-and-right screw thread rod rotates, the movable ends of the two groups (the left group and the right group) of the X-shaped connecting rods are driven to move, so as to realize lifting and lowering the horizontal lifting platform.

What the technical solution further comprises is as following.

The left-and-right screw thread rod comprises a screw rod which has both a left thread and a right thread provided thereon, wherein a left screw thread section is connected with a first group of the two groups (the left group and the right group) of the X-shaped connecting rods, and a right screw thread section is connected with a second group of the two groups (the left group and the right group) of the X-shaped connecting rods.

The base comprises a frame, two borders of the frame serve as guide rails, and walking wheels are provided below the frame;

the horizontal lifting platform comprises a frame, two borders of the frame serve as guide rails;

the left-and-right screw thread rod comprises a left-hand thread section and a right-hand thread section which are respectively provided on one screw rod, a first guide rod and a second guide rod are respectively provided on two sides of the left-and-right screw thread rod, the left-and-right screw thread rod, the first guide rod and the second guide rod respectively pass through a left-hand driving block and a right-hand driving block, and two ends of the first guide rod and two ends of the second guide rod are respectively provided in fixing blocks for end portion of the guide rods;

each of the X-shaped connecting rod comprises a stabilizing arm and a driving arm which are hinged together in middle portions thereof, wherein a first end of each driving arm in the two groups of the X-shaped connecting rods is hinged on the base, second ends of the driving arms are respectively hinged on the left-hand driving guide block and the right-hand driving guide block; a first end of the stabilizing arm is hinged on the fixing block for end portion of the guide rod, a second end of the stabilizing arm is supported on guide rails of the base and moves on the guide rails, wherein by changes of an included angle between the stabilizing arm and the driving arm, movement of lifting and lowering the horizontal lifting platform is accomplished.

Two screw threads are provided, which replace the first and the second guide rods.

The transmitting portion is an electric motor or a reduction device which is in a form of gear transmission, synchronous belt transmission, reduction gearbox transmission or chain transmission. At least one horizontal lifting working plane is provided above the horizontal lifting platform, wherein the horizontal lifting working plane comprises a frame, two borders of the frame serve as guide rails,

wherein the horizontal lifting working plane is connected with the horizontal lifting platform via two groups of, i.e. a left group and a right group, X-shaped connecting rod,

wherein a first end of each of the driving arm is hinged on the horizontal lifting working plane, and second ends of the driving arms are respectively hinged on the left-hand driving guide block and the right-hand driving guide block; a first end of the stabilizing arm is hinged on the fixing block for end portion of the guide rod, a second end of the stabilizing arm is supporting below guide rails of the horizontal lifting working plane, and moves below the guide rails, the stabilizing arm and the driving arm are hinged together in middle portions, when the driving guide block slides on the first guide rod and the second guide rod, the driving guide block drives the driving arm to swing, accordingly the driving arm drives the stabilizing arm to swing, end portion of the stabilizing arm moves below the guide rail, and by changes of an included angle between the stabilizing arm and the driving arm, movement of lifting and lowering the horizontal lifting working planes is accomplished.

wherein the horizontal lifting working plane is connected with the horizontal lifting platform via two groups of, i.e. a left group and a right group, X-shaped connecting rod,

wherein a first end of the driving arm is hinged on upper layer of the horizontal lifting working plane, and a second end of the driving arm is hinged on a first end of the stabilizing arm on a lower layer of the horizontal lifting working plane; a first end of the stabilizing arm is hinged on the lower layer of the horizontal lifting working plane, a second end of the stabilizing arm is supporting below guide rails on an upper layers of the horizontal lifting working plane, and moves below the guide rails, and by changes of included angle between the stabilizing arm and the driving arm, movement of lifting and lowering the horizontal lifting working plane is accomplished.

The electric motor reduction gearbox is mounted on an electric motor reduction gearbox mounting plate, wherein the electric motor reduction gearbox mounting plate is mounted on the first guide rod and the second guide rod. A bearing is provided on a hinging end of the driving arm, bearings are provided on hinging end and supporting end of the stabilizing arm, and bearings are respectively provided between the left-and-right screw thread rod and the fixing block for end portion of the guide rod.

The two groups of X-shaped connecting rods comprise four X-shaped connecting rods in total, which are respectively provided on two sides between the horizontal lifting platform and the base.

The two groups of X-shaped connecting rods comprise four X-shaped connecting rods in total, which are respectively provided on two sides between the horizontal lifting platform and the horizontal lifting working plane.

The driving arms comprise a left driving arm and a right driving arm, wherein a lower end of the left driving arm is hinged on the base, an upper end of the left driving arm is hinged on the right-hand driving block; a lower end of the right driving arm is hinged on the base, and an upper end of the left driving arm is hinged on the left-hand driving block.

Beneficial effects of the present invention are as following. The lifting platform of the present invention has characteristics of simple in structure, good stability, small space occupation, easy operation and wide range of application.

### BRIEF DESCRIPTION OF THE DRAWINGS

FIG. 1 is a front view of a screw-driven lifting platform according to a preferred embodiment 1 of the present invention, showing a lifting up state.

FIG. 2 is a top view of FIG. 1.

FIG. 3 is an assembled structure diagram of a base and a horizontal lifting platform, showing transmitting structures of chain wheels and chains.

FIG. 4 is a top view of FIG. 3.

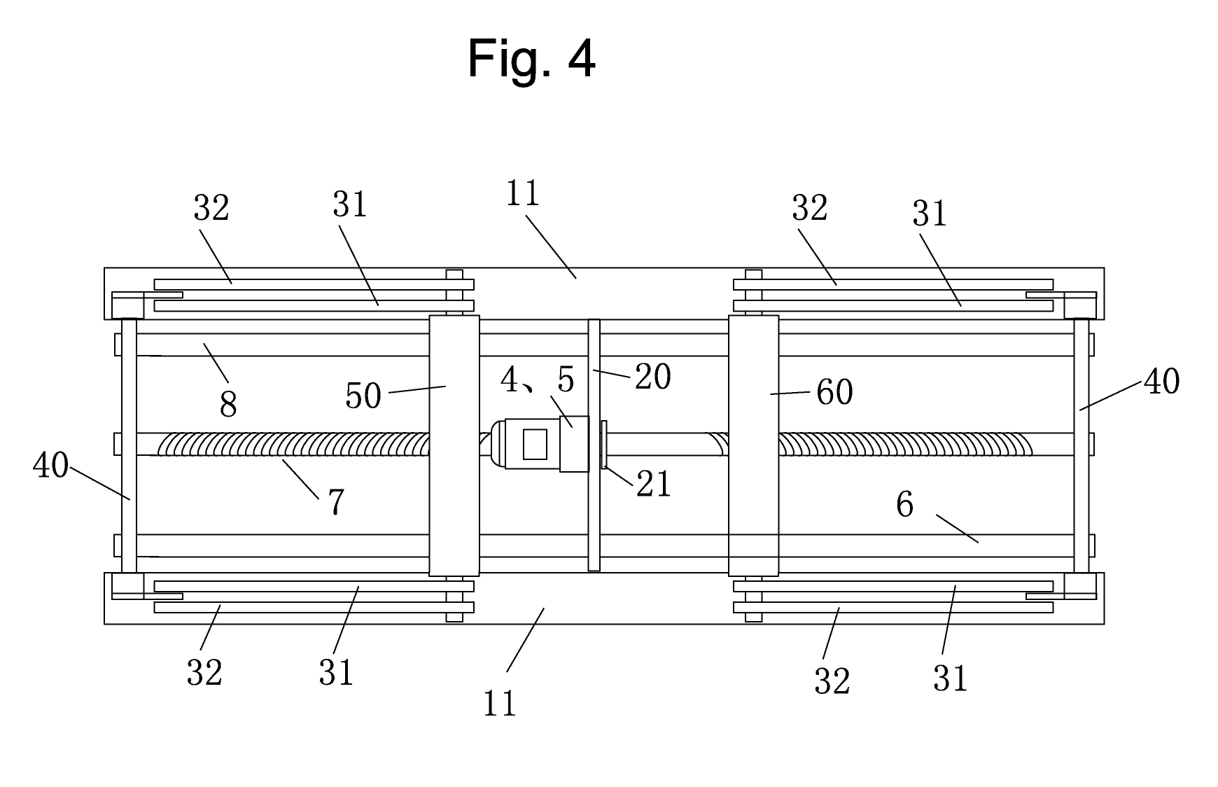

FIG. 5 is a three-dimensional schematic view of FIG. 3.

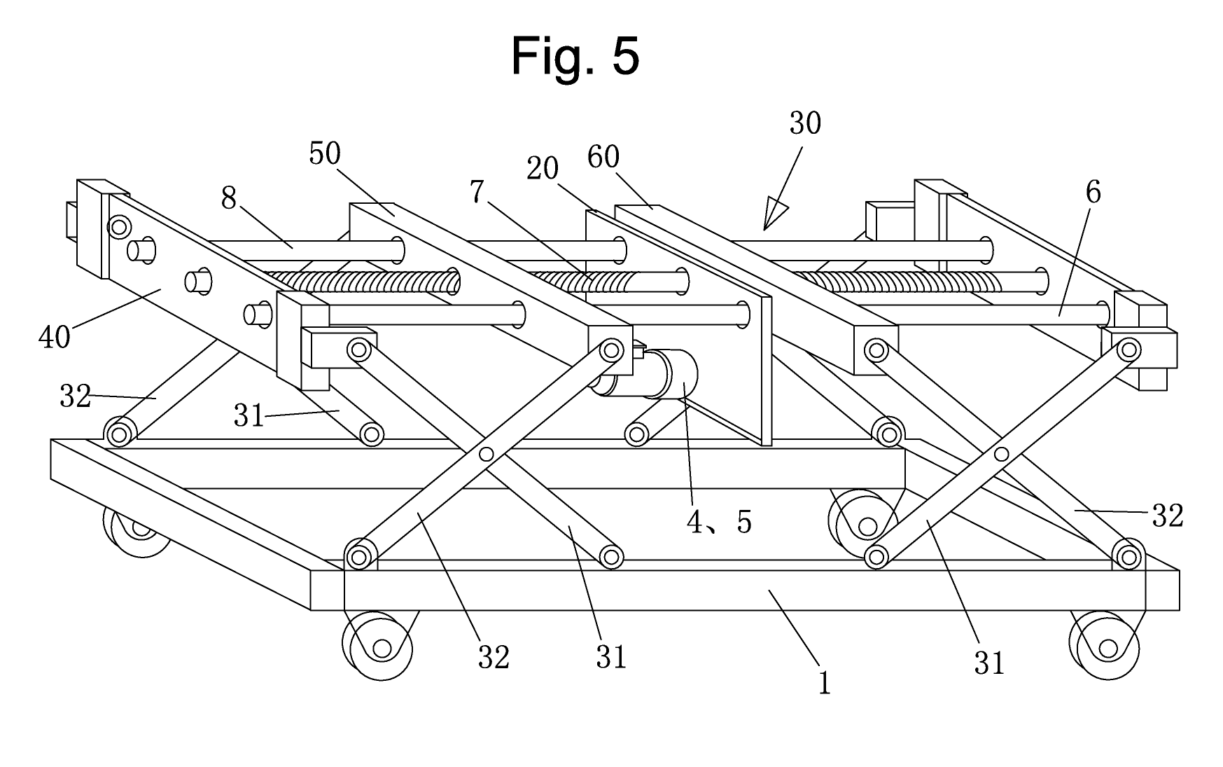

FIG. 6 is a schematic view of the transmitting structures of the chain wheels and chains in FIG. 1 according to one preferred transmitting form.

FIG. 7 is a three-dimensional schematic view of FIG. 6.

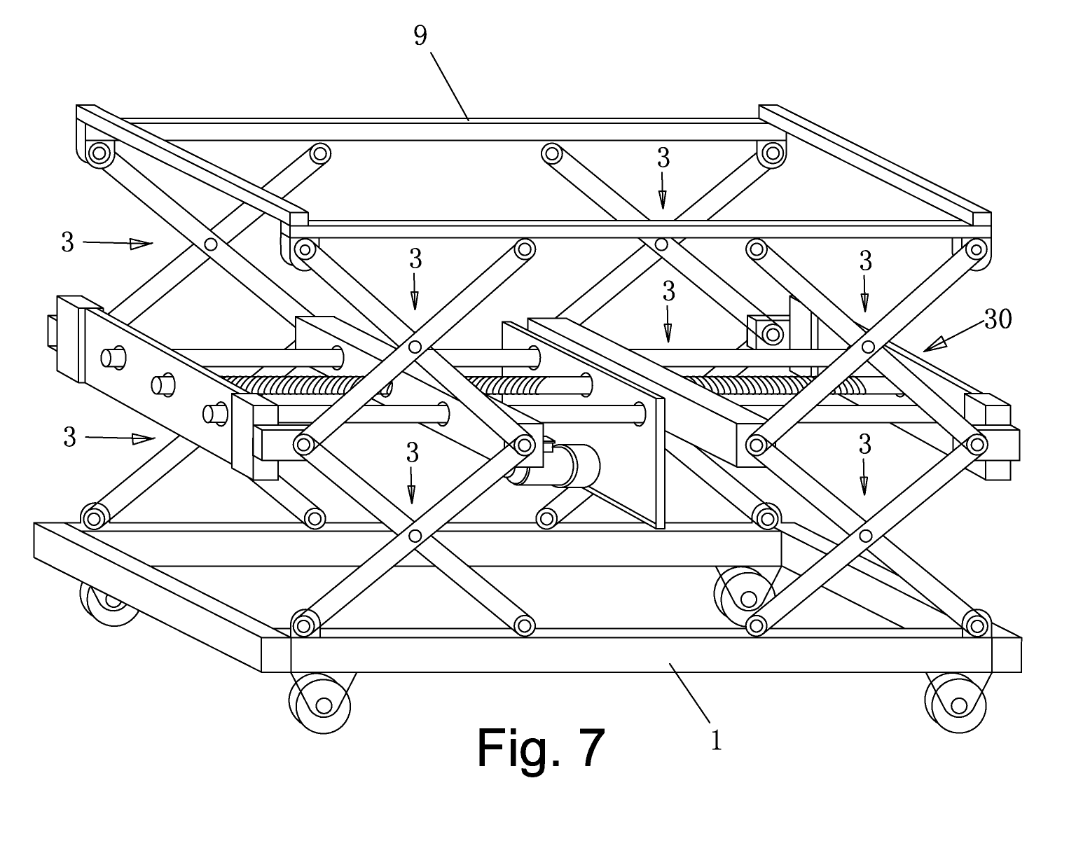

FIG. 8 is an assembly exploded view of FIG. 7.

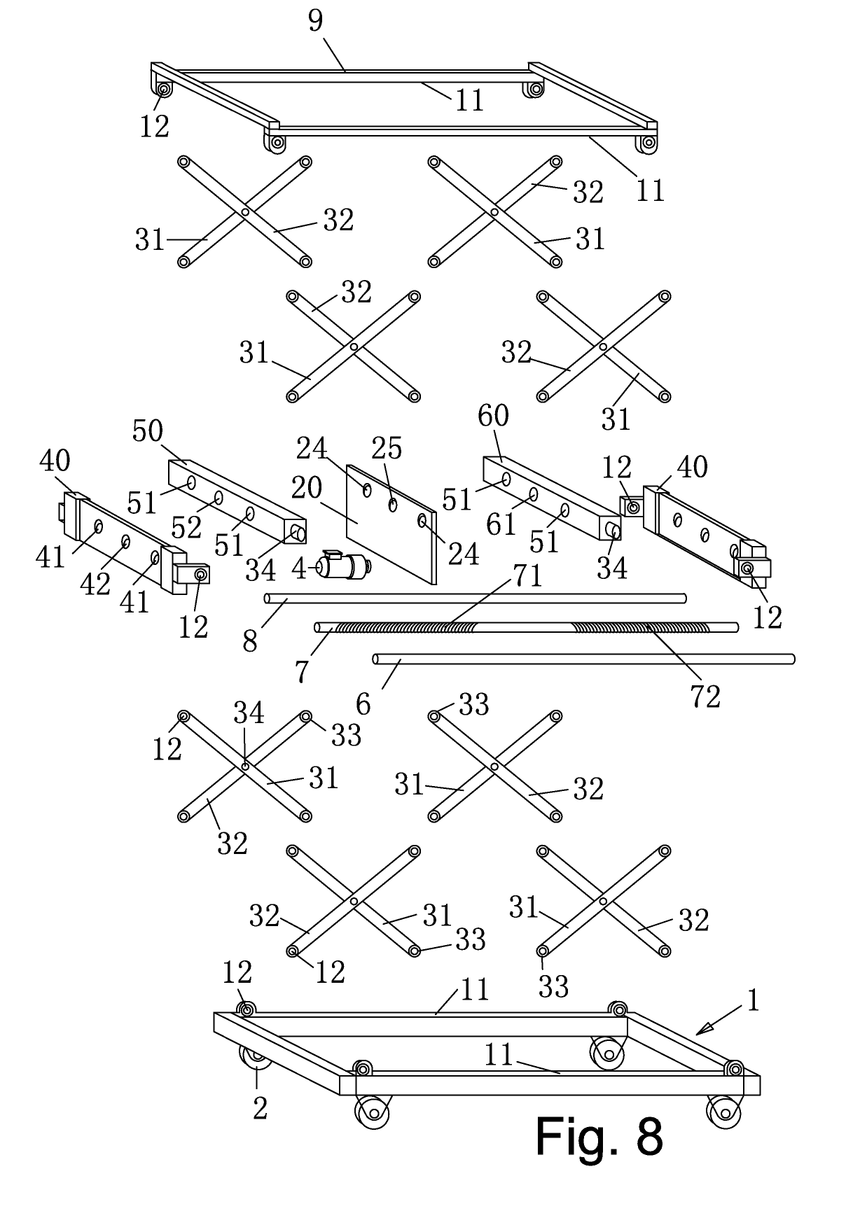

FIG. 9 is a front view of a screw-driven lifting platform according to a preferred embodiment 2 of the present invention, showing a lifting up state.

FIG. 10 is a top view of FIG. 9.

Numbers of elements in the drawings: 1-base; 11-guide rail; 12-hinge hole; 2-walking wheel; 3-X-shaped connecting rod; 31-stabilizing arm; 32-driving arm; 33-bearing; 34-hinge shaft; 4-electric motor; 5-reduction gearbox; 6-first guide rod; 7-left-and-right screw thread rod; 71-left-hand thread section; 72-right-hand thread section; 8-second guide rod; 9-horizontal lifting working plane; 20-electric motor reduction gearbox mounting plate; 21-driven chain wheel; 22-chain; 23-driving chain wheel; 24-connecting hole; 25-receiving hole; 30-horizontal lifting platform; 40-fixing block for end portion of guide rod; 41-fixing hole for guide rod; 42-left-and-right screw thread rod supporting hole; 50-left-hand driving guide block; 51-guide holes; 52-left-hand inner thread hole; 60-right-hand driving block; 61-right-hand inner thread hole.

### DETAILED DESCRIPTION OF THE PREFERRED EMBODIMENT

Combined with the accompanying drawings and the preferred embodiments, further description of the present invention is illustrated as following.

The screw-driven lifting platform of the present invention mainly comprises a lifting portion and a transmitting portion.

The screw-driven lifting platform mainly comprises a base 1, a left-and-right screw thread rod 7, two groups (a left and a right group) of X-shaped connecting rods 3, a horizontal lifting platform 30 and etc. The key technique is driving the two groups of X-shaped connecting rods to move by the left-and-right screw thread rod, so as to realize a horizontal lifting function.

The two groups (the left group and the right group) of the X-shaped connecting rods 3 are respectively provided on left and right end portions between the base 1 and the horizontal lifting platform 30. Fixed ends of each X-shaped connecting rod 3 are respectively hinged on the base 1 and the horizontal lifting platform 30. Movable ends of each X-shaped connecting rod 3 are connected with the left-and-right screw thread rod 7. When the left-and-right screw thread rod 7 rotates, the movable ends of the two groups (the left group and the right group) of the X-shaped connecting rods 3 are driven to move, so as to realize lifting and lowering the horizontal lifting platform 30. The left-and-right screw thread rod 7 can be embodied as one screw rod with left and right threads, or embodied as two screw rods wherein one screw rod with a left thread and the other screw rod with a right thread. Structure of the base 1 is a frame in a shape of a closed rectangular. Two borders on the surface of the frame serve as guide rails 11. Hinge holes 12 for connecting with the X-shaped connecting rods 3 are provided above four corners of the frame. Walking wheels 2 are provided below the four corners of the frame.

### Embodiment 1

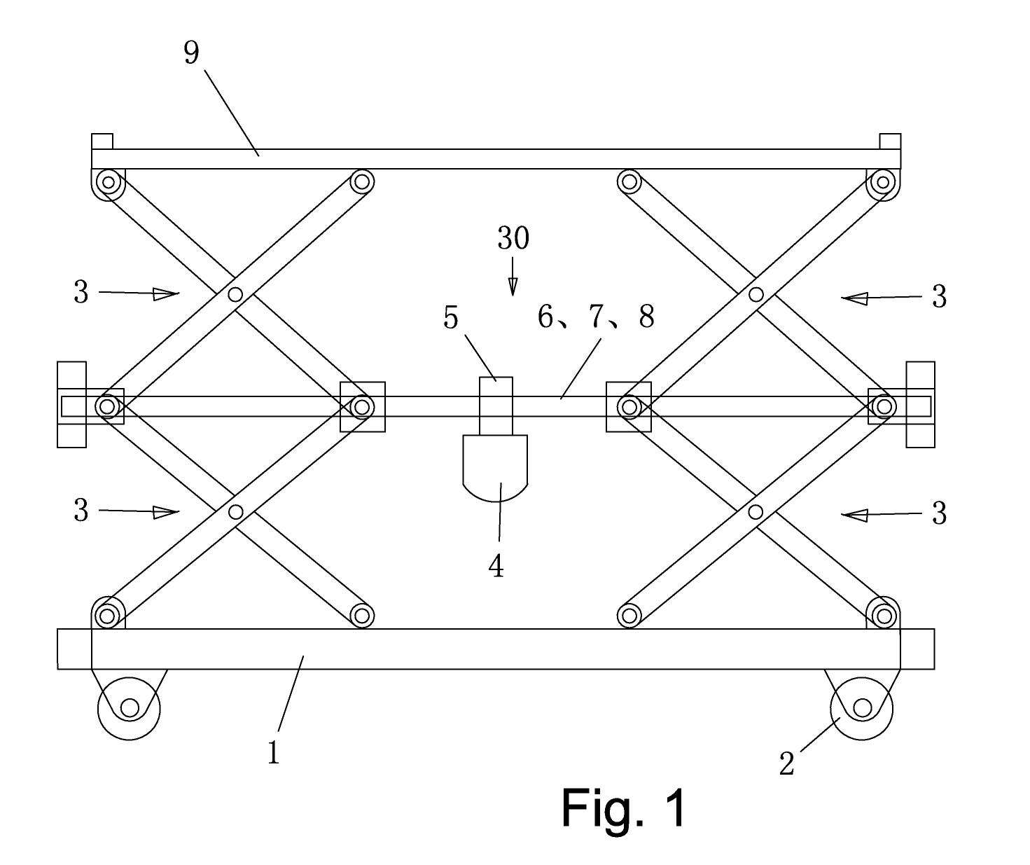

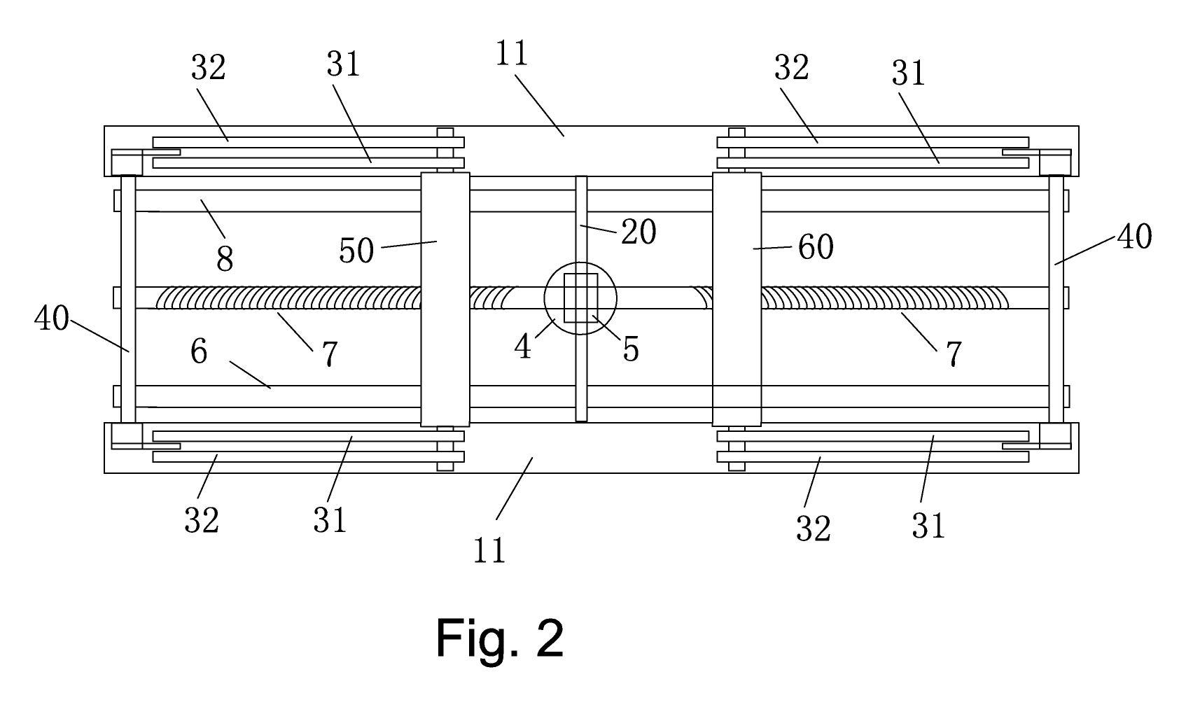

As shown in FIG. 1-3, the screw-driven lifting platform mainly comprises a base 1, a left and a right group of X-shaped connecting rods 3, a horizontal lifting platform 30 and a horizontal lifting working plane 9 and etc. The key technique is driving two groups of X-shaped connecting rods to move by the left-and-right screw thread rod, so as to realize a horizontal lifting function.

Structure of the base 1 is a frame in a shape of a closed rectangular. Two borders on the surface of the frame serve as guide rails 11. Hinge holes 12 for connecting with the X-shaped connecting rods 3 are provided above four corners of the frame. Walking wheels 2 are provided below the four corners of the frame.

The left and the right group of X-shaped connecting rods 3 comprise a stabilizing arm 31 and a driving arm 32. The stabilizing arm 31 and the driving arm 32 are crossed and hinged together in middle portions thereof.

The horizontal lifting platform 30 comprises a left-and-right screw thread rod 7, a first guide rod 6, a second guide rod 8, fixing blocks 40 for end portion of the guide rods, a left-hand driving guide block 50, a right-hand driving guide block 60, an electric motor 4, a reduction gearbox 5, an electric motor reduction gearbox mounting plate 20 and etc. The left-and-right screw thread rod 7 has a left-hand thread section 71 and a right-hand thread section 72, and a driven chain wheel 21 is fixed on a middle portion of the left-and-right screw thread rod 7. A left-hand inner thread hole 52 is provided on a middle portion of the left-hand driving guide block 50, two guide holes 51 are respectively provided on two sides of the left-hand inner thread hole 52, hinge shafts 34 are provided on two ends of the left-hand driving guide block 50. A right-hand inner thread hole 61 is provided on a middle portion of the right-hand driving guide block 60, two guide holes 51 are provided on two sides of the right-hand inner thread hole 61, and hinge shafts 34 are provided on two ends of the right-hand driving guide block 60. A left-and-right screw thread rod supporting hole 42 is provided on a middle portion of the fixing block 40 for end portion of the guide rod, fixing holes 41 for guide rod are provided on two sides of the left-and-right screw thread rod supporting hole 42, hinge holes 12 are provided on two ends of the fixing block 40. A receiving hole 25 is provided on a middle portion of the electric motor reduction gearbox mounting plate 20, and connecting holes 24 are provided on two sides of the receiving hole 25.

Structure of the horizontal lifting working plane 9 is a frame in a shape of a closed rectangular. Lower portions of two borders of the frame serves as guide rails 11, hinge holes 12 for connecting with the X-shaped connecting rod 3 are provided below four corners of the frame.

Connections

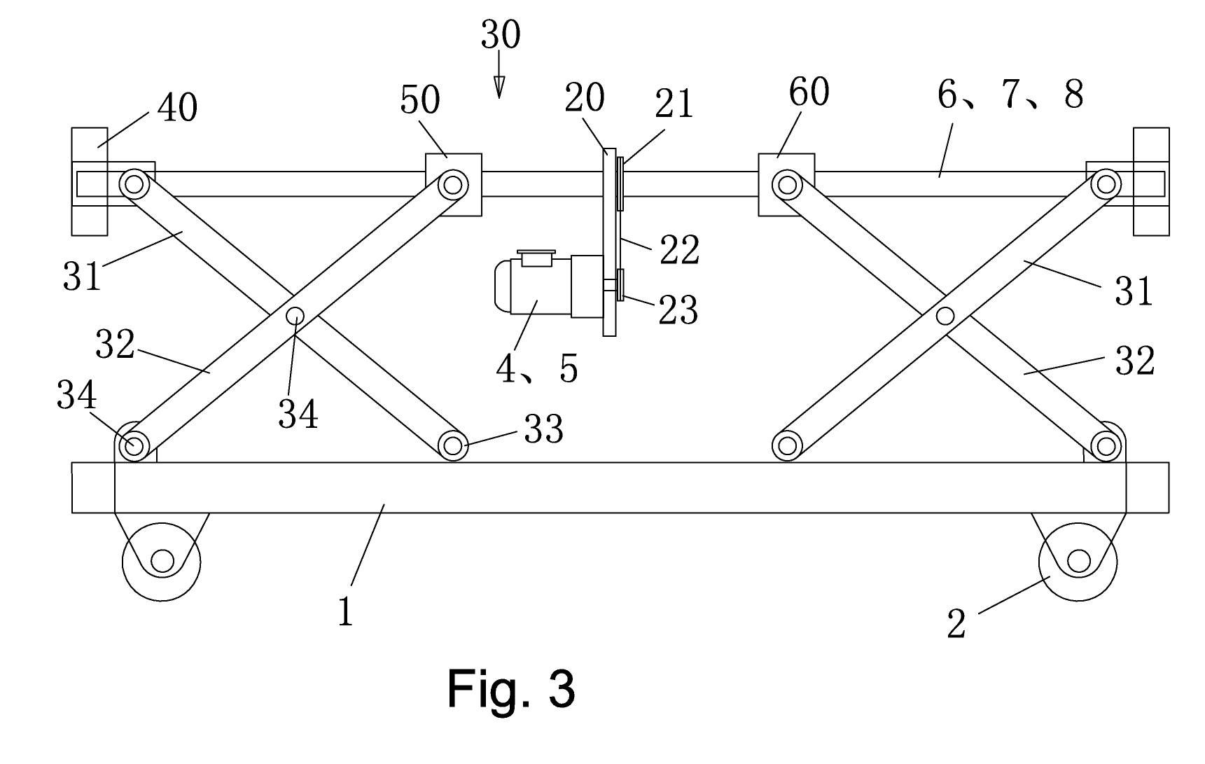

The two groups of (four in total) X-shaped connecting rods 3 are connected between the base 1 and the horizontal lifting platform 30 (see FIG. 3);

two ends of the left-and-right screw thread rod 7 respectively pass through the left-hand inner thread hole 52 provided on the middle portion of the left-hand driving guide block 50, the receiving hole 25 provided on the middle portion of the electric motor reduction gearbox mounting plate 20, and the right-hand inner thread hole 61 provided on the middle portion of the right-hand driving guide block 60. The two ends of the left-and-right screw thread rod 7 are respectively provided on bearings (not shown in the drawings) which are provided in the left-and-right screw thread rod supporting holes 42 on the two fixing block 40;

the left-hand thread section 71 and the right-hand thread section 72 are respectively engaged with the left-hand inner thread hole 52 and the right-hand inner thread hole 61;

two ends of the first guide rod 6 and two ends of the second guide rod 8 respectively pass through the guide holes 51 of the left-hand driving guide block 50, the connecting holes 24 of the electric motor reduction gearbox mounting plate 20, and the guide holes 51 of the right-hand driving guide block 60, the two ends of the first guide rod 6 and the two ends of the second guide rod 8 are respectively fixed on the fixing holes 41 for guide rod on the two fixing blocks 40;

the connecting holes 24 of the electric motor reduction gearbox mounting plate 20 are fixed on the first guide rod 6 and the second guide rod 8, the reduction gearbox 5 for the electric motor 4 is fixed on the electric motor reduction gearbox mounting plate 20, the reduction gearbox 5 for the electric motor 4 are directly engaged with the left-and-right screw thread rod 7 (Referring to FIG. 1, this kind of structure does not require the driving chain wheel 23, the chain 22 and the driven chain wheel 21);

lower ends of the four driving arms 32 are respectively hinged the hinge holes 12 provided on the four corners of the base 1, upper ends of the four driving arms 32 are respectively hinged on the hinge shafts 34 on the left-hand driving guide block 50 and the right-hand driving guide block 60;

upper ends of the four stabilizing arms 31 are hinged on hinge holes 12 on the two fixing blocks 40 for end portion of the guide rod, lower ends of the four stabilizing arms 31 are supporting on the guide rails 11 of the base 1, and move on the guide rails 11, the driving arm 31 and the driven arm 32 are crossed and hinged together in middle portions.

Bearings are provided in the hinge holes 12, and manufacturing material is preferred metal material.

Working Principle

The electric motor 4 rotates, the driving chain wheel 23 drives the driven chain wheel 21 to rotate, and the driven chain wheel 21 drive the left-and-right screw thread rod 7 to rotate. Chain driving shown in the drawings is merely one of driving modes thereof, other driving modes such as synchronous belt, gear driving and reduction box directly driving can be adopted as well. Then, under rotation of the left-and-right screw thread rod 7, the left-hand driving guide block 50 and the right-hand driving block 60 start to slide in a straight line on the first guide rod 6 and the second guide rod 8. The left-hand driving block 50 and the right-hand driving block 60 drives the driving arm 32 to move (swings in a circle around hinge point on the lower end). As the stabilizing arm 31 is hinged together with the driving arm 32, the stabilizing arm 31 moves accordingly (swings in a circle around hinge point on the upper end). At this moment, the lower end of the stabilizing arm 31 moves along the guide rail 11. The lifting and lowering movement of the horizontal lifting platform 30 is accomplished by changing of included angle between the stabilizing arm 31 and the driving arm 32. When the included angle therebetween decreases, the horizontal lifting platform 30 is lifted; when the included angle therebetween increases, the horizontal lifting platform 30 is lowered.

### Embodiment 2

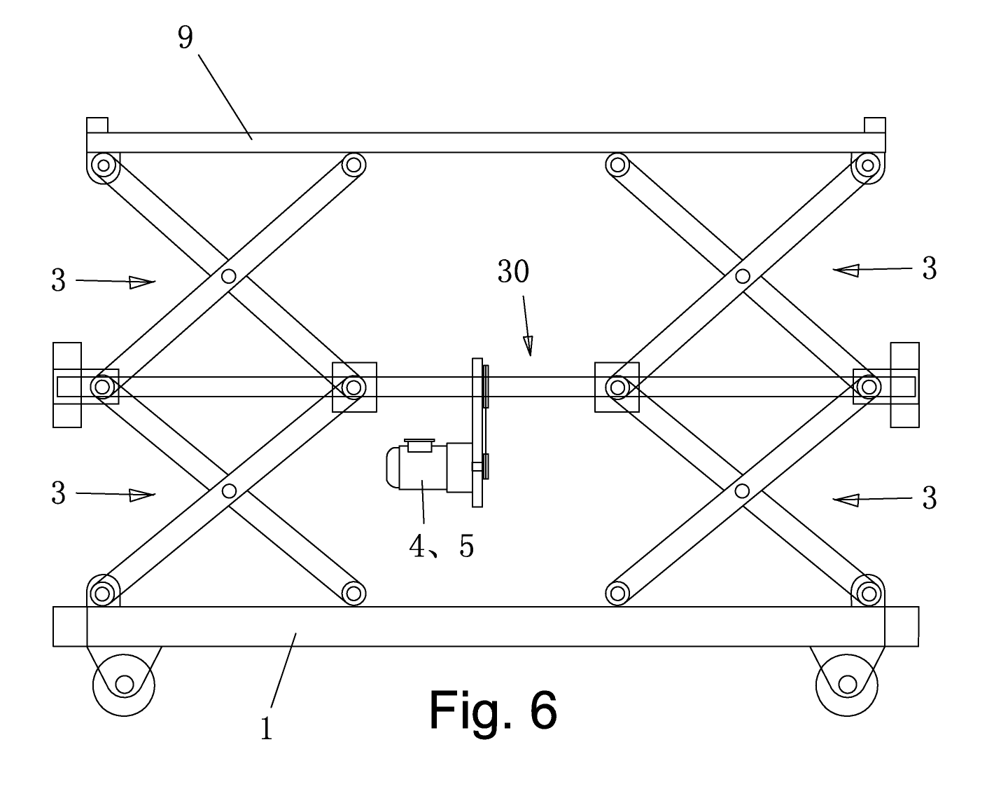

As shown in FIG. 1 and FIG. 6, a horizontal lifting working plane 9 is added above the horizontal lifting platform 30. The horizontal lifting working plane 9 is connected with the horizontal lifting platform 30 via two groups of (a left group and a right group) and four in total X-shaped connecting rod 3.

The upper ends of the four driving arms are hinged on hinge holes 12 below four corners of the horizontal lifting working plane 9, and the lower ends of the four driving arms are respectively hinged on the hinge shafts 34 on the left-hand driving guide block 50 and the right-hand driving guide block 60. The lower ends of the four stabilizing arms are hinged on the hinge holes 12 on fixing block 40 for end portion of the guide rod, the upper ends of the four stabilizing arms are supporting on guide rails 11 on the horizontal lifting working plane 80, and move on the guide rails 11. Middle portions of each stabilizing arm 31 and the driving arm 32 are hinged together via the hinge shaft 34.

Working Principle

When the first guide rod 6 and the second guide rod 8 start to slide in a straight line, the left-hand driving block 50 and the right-hand driving block 60 similarly drive the driving arm 32 to move (swing in a circle around hinge point on the upper end). As the stabilizing arm 31 is hinged together with the driving arm 32, the stabilizing arm 31 moves accordingly (swings in a circle around hinge point on the lower end) as well. At this moment, the upper end of the stabilizing arm 31 moves along the guide rail 11. The lifting and lowering movement of the horizontal lifting working plane 9 is accomplished by changes of included angle between the stabilizing arm 31 and the driving arm 32. When the included angle therebetween decreases, the horizontal lifting working plane 9 is lifted; when the included angle therebetween increases, the horizontal lifting working plane 9 is lowered.

Multilayer of the horizontal lifting working plane 9 can be provided according to height requirements. When multilayer of the horizontal lifting working plane 9 is adopted, the layers of the horizontal lifting working plane 9 are connected by the stabilizing arm 31 and the driving arm 32 which are hinged together in middle portions thereof. A first end of the driving arm 32 is hinged on an upper layer of the horizontal lifting working plane 9, and a second end of the driving arm 32 is hinged on the stabilizing arm 31 on an lower layer of the horizontal lifting working plane 9. A first end of the stabilizing arm 31 is hinged on the lower layer of the horizontal lifting working planes 9, a second end of the stabilizing arm 31 is supporting below guide rails 11 on the upper layer of the horizontal lifting working plane 9, and moves below the guide rail 11. By changes of included angle between the stabilizing arm 31 and the driving arm 32, movement of lifting and lowering of the horizontal lifting working plane 9 is accomplished. The working principle is basically the same with the embodiment 1.

Embodiment 3

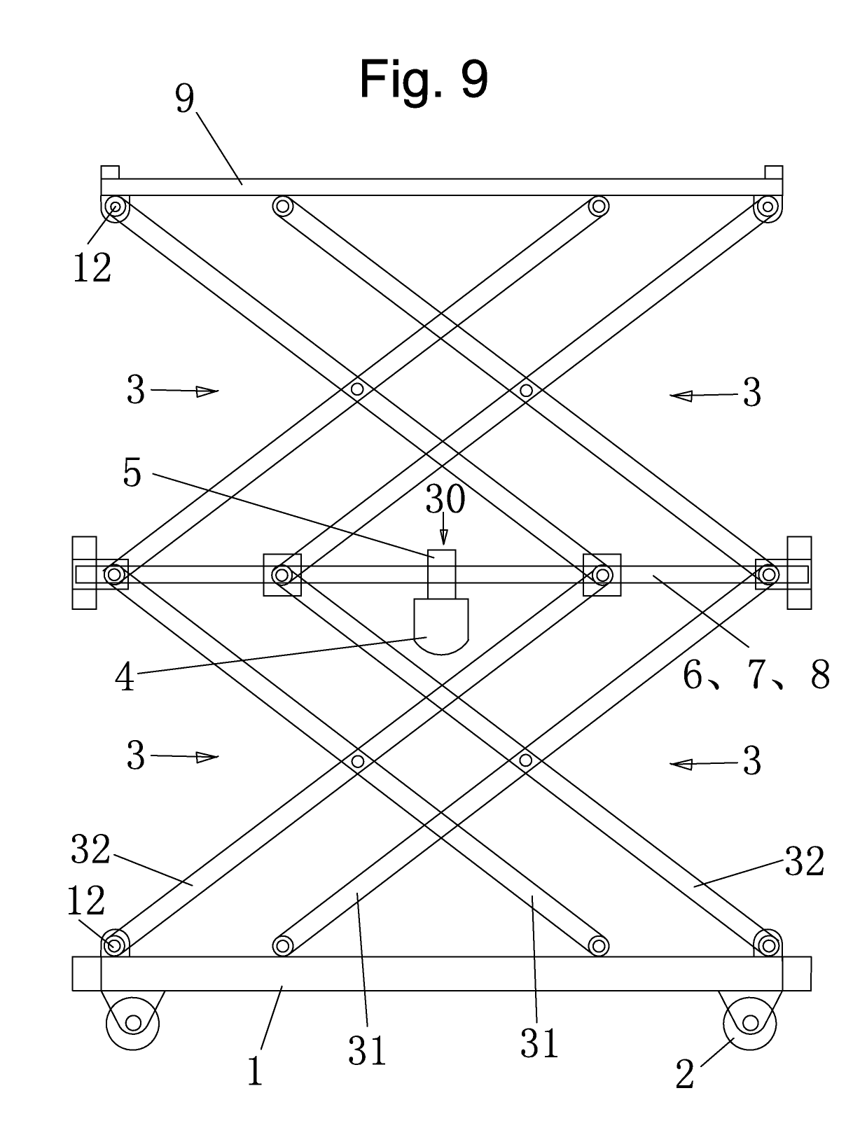

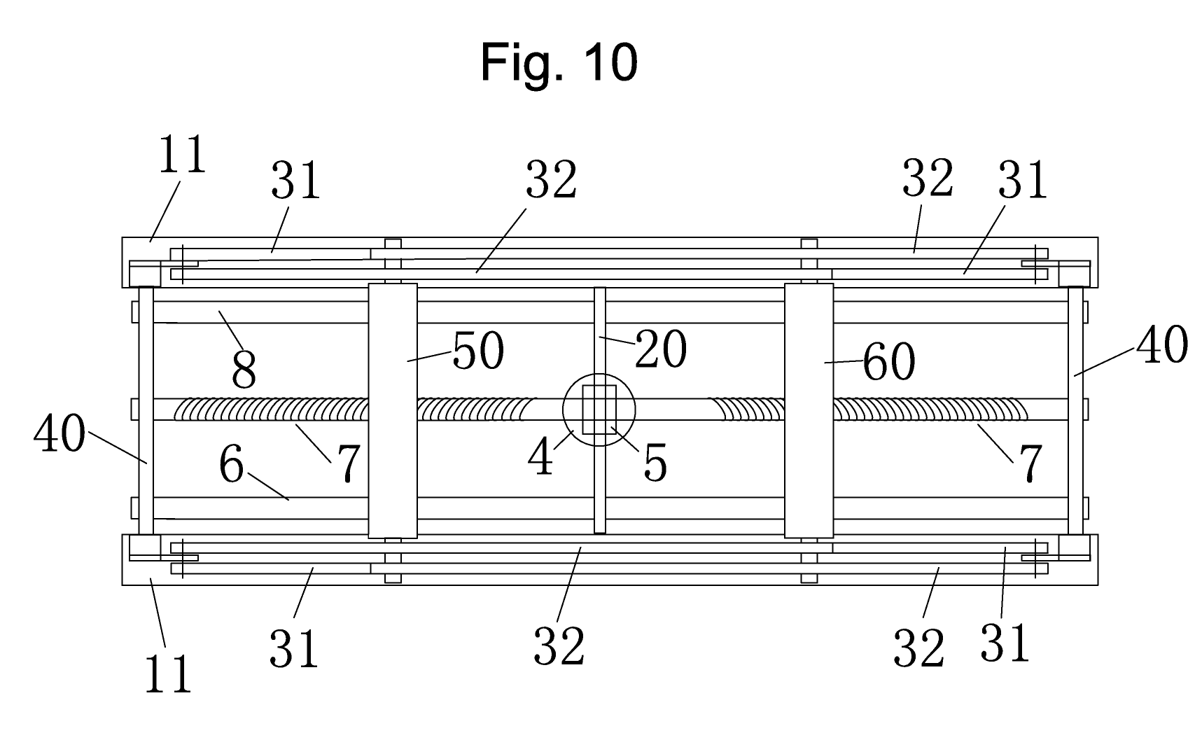

As shown in FIGS. 9-10, embodiment 3 is an improvement based on the embodiment 1. Improved connections are as following. The lower portion of the driving arm 32 on the left is hinged on the base 1, and the upper portion of the driving arm 32 on the left is hinged on the right-hand driving block. (While in the embodiment 1, the lower portion of the driving arm 32 on the left is hinged on the base 1, and the upper portion of the driving arm 32 on the left is hinged on the left-hand driving block.) The lower portion of the driving arm 32 on the right is hinged on the base 1, and the upper portion of the driving arm 32 on the right is hinged on the left-hand driving block. (While in the embodiment 1, the lower portion of driving arm 32 on the right is hinged on the base 1, and the upper portion of the driving arm 32 on the right is hinged on the right-hand driving block.) Thus, distance that the driving arms moves doubles, which causes the height of the horizontal lifting platform lifted doubles too. Other structures and connections are basically the same with the embodiment 1 and the embodiment 2.

What is claimed is:

1. A screw-driven lifting platform, comprising a lifting portion and a driving portion, which is characterized in comprising a base, a left-and-right screw thread rod, two groups, i.e. a left and a right group, of X-shaped connecting rods and a horizontal lifting platform, wherein said two groups of said X-shaped connecting rods are respectively provided on left and right end portions between said base and said horizontal lifting platform, fixed ends of said X-shaped connecting rod are respectively hinged on said base and said horizontal lifting platform, movable ends of said X-shaped connecting rod are connected with said left-and-right screw thread rod, when said left-and-right screw thread rod rotates, said movable ends of said two groups of said X-shaped connecting rod are driven to move, so as to realize lifting and lowering said horizontal lifting platform.

2. The screw-driven lifting platform, as recited in claim 1, which is characterized in that said left-and-right screw thread rod comprises a screw rod which has both a left thread and a right thread provided thereon, wherein a left screw thread section is connected with a first group of said two groups of said X-shaped connecting rods, and a right screw thread section is connected with a second group of said two groups of said X-shaped connecting rods.

3. The screw-driven lifting platform, as recited in claim 1, which is characterized in that:
said base comprises a frame, two borders of said frame serve as guide rails, and walking wheels are provided below said frame;
said horizontal lifting platform comprises a frame, two borders of said frame serve as guide rails;
said left-and-right screw thread rod comprises a left-hand thread section and a right-hand thread section which are respectively provided on one screw rod, a first guide rod and a second guide rod are respectively provided on two sides of said left-and-right screw thread rod, said left-and-right screw thread rod, said first guide rod and said second guide rod pass through a left-hand driving block and a right-hand driving block, and two ends of said first guide rod and two ends of said second guide rod are respectively provided in fixing blocks for end portion of said guide rods;
each of said X-shaped connecting rod comprises a stabilizing arm and a driving arm which are hinged together in middle portions thereof, wherein a first end of each said driving arm in the two groups of the X-shaped connecting rods is hinged on said base, second ends of said driving arms are respectively hinged on said left-hand driving guide block and said right-hand driving guide block; a first end of said stabilizing arm is hinged on said fixing block for end portion of said guide rod, a second end of said stabilizing arm is supporting on guide rails of said base and moves on said guide rails, wherein by changes of included angle between said stabilizing arm and said driving arm, movement of lifting and lowering of said horizontal lifting platform is accomplished.

4. The screw-driven lifting platform, as recited in claim 3, which is characterized in that two screw threads are provided, which replace said first and said second guide rods.

5. The screw-driven lifting platform, as recited in claim 3, which is characterized in that said transmitting portion is an electric motor or a reduction device which is in a form of gear transmission, synchronous belt transmission, reduction gearbox transmission or chain transmission.

6. The screw-driven lifting platform, as recited in claim 3, which is characterized in that at least one horizontal lifting working plane is provided above said horizontal lifting platform, wherein said horizontal lifting working plane comprises a frame, two borders of said frame serve as guide rails,
wherein said horizontal lifting working plane is connected with said horizontal lifting platform via two groups of, i.e. a left group and a right group, X-shaped connecting rod,
wherein a first end of said driving arm is hinged on said horizontal lifting working plane, and second ends of said driving arms are respectively hinged on said left-hand driving guide block and said right-hand driving guide block; a first end of said stabilizing arm is hinged on said fixing block for end portion of said guide rod, a second end of said stabilizing arm is supporting below guide rails of said horizontal lifting working plane, and moves below said guide rails, said stabilizing arm and said driving arm are hinged together in middle portions, when said driving guide block slides on said first guide rod and said second guide rod, said driving guide block drives said driving arm to swing, accordingly said driving arm drives said stabilizing arm to swing, end portion of said stabilizing arm moves below said guide rail, and by changes of included angle between said stabilizing arm and said driving arm, movement of lifting and lowering said horizontal lifting working planes is accomplished.
wherein said horizontal lifting working plane is connected with said horizontal lifting platform via two groups of, i.e. a left group and a right group, X-shaped connecting rod,
wherein a first end of said driving arm is hinged on upper layer of said horizontal lifting working plane, and a second end of said driving arm is hinged on a first end of said stabilizing arm on a lower layer of said horizontal lifting working plane; a first end of said stabilizing arm is hinged on the lower layer of said horizontal lifting working plane, a second end of said stabilizing arm is supporting below guide rails on an upper layers of said horizontal lifting working plane, and moves below said guide rails, and by changes of included angle between said stabilizing arm and said driving arm, movement of lifting and lowering said horizontal lifting working planes is accomplished.

7. The screw-driven lifting platform, as recited in claim 5, which is characterized in that an electric motor reduction gearbox is mounted on an electric motor reduction gearbox mounting plate, wherein said electric motor reduction gearbox mounting plate is mounted on said first guide rod and said second guide rod.

8. The screw-driven lifting platform, as recited in claim 3, which is characterized in that a bearing is provided on a hinging end of said driving arm, bearings are provided on hinging end and supporting end of said stabilizing arm, and bearings are respectively provided between said left-and-right screw thread rod and said fixing block for end portion of said guide rod.

9. The screw-driven lifting platform, as recited in claim 1, which is characterized in that said two groups of X-shaped connecting rods comprise four X-shaped connecting rods in total, which are respectively provided on two sides between said horizontal lifting platform and said base.

10. The screw-driven lifting platform, as recited in claim 6, which is characterized in that said two groups of X-shaped connecting rods comprise four X-shaped connecting rods in total, which are respectively provided on two sides between said horizontal lifting platform and said horizontal lifting working plane.

11. The screw-driven lifting platform, as recited in claim 3, which is characterized in that said driving arms comprise a left driving arm and a right driving arm, wherein a lower end of said left driving arm is hinged on said base, an upper end of said left driving arm is hinged on said right-hand driving block; a lower end of said right driving arm is hinged on said base, an upper end of said left driving arm is hinged on said left-hand driving block.
